(19) United States
(12) Patent Application Publication
(10) Pub. No.: US 2021/0370891 A1
(43) Pub. Date: Dec. 2, 2021

(54) INFORMATION PROCESSING DEVICE, NON-TRANSITORY COMPUTER-READABLE STORAGE MEDIUM, AND INFORMATION PROCESSING METHOD

(71) Applicant: Mitsubishi Electric Corporation, Tokyo (JP)

(72) Inventors: Takehiko HANADA, Tokyo (JP); Katsuki KOBAYASHI, Tokyo (JP); Yosuke ISHIWATARI, Tokyo (JP)

(73) Assignee: Mitsubishi Electric Corporation, Tokyo (JP)

(21) Appl. No.: 17/400,669

(22) Filed: Aug. 12, 2021

Related U.S. Application Data
(63) Continuation of application No. PCT/JP2019/005828, filed on Feb. 18, 2019.

(51) Int. Cl. B60T 7/12

(52) U.S. Cl. CPC B60T 7/12; B60T 2250/04; B60T 2210/32

(57) ABSTRACT

An information processing device includes a processor to execute a program; and a memory to store the program which, when executed by the processor, performs processes of, calculating braking time of a host vehicle; detecting reaction time of the driver of the host vehicle; specifying longer prediction time as the sum of the braking time and the reaction time becomes longer, the prediction time being a range of a time at which a collision between the host vehicle and a surrounding vehicle is predicted in the future; making a prediction of the position and speed of the host vehicle and the position and speed of the surrounding vehicle at a time point included in the prediction time; and predicting, from a result of the prediction, whether or not the host vehicle and surrounding vehicle will collide.

### CROSS-REFERENCE TO RELATED APPLICATION

This application is a continuation application of International Application No. PCT/JP2019/005828 having an international filing date of Feb. 18, 2019, the disclosure of which is incorporated herein by reference in its entirety.

### BACKGROUND OF THE INVENTION

### 1. Field of the Invention

The present invention relates to an information processing device, a program, and an information processing method.

### 2. Description of the Related Art

Conventionally, a device has been developed that detects a trailing vehicle and warns a driver to assist the driving of a host vehicle.

For example, the left-right-turn assist device described in Patent Literature 1 uses a radar mounted on the rear side of a host vehicle driven by a driver to detect a target vehicle traveling behind the host vehicle, and specifies the intersection of the estimated trajectory of the host vehicle and the estimated trajectory of the detected target vehicle. The left-right-turn assist device notifies the driver of the risk of a collision with the detected target vehicle traveling behind when the host vehicle turns to the left or right or changes lanes, by issuing a danger signal if the estimated time of arrival of the host vehicle at the specified intersection is later than the estimated time of arrival of the target vehicle. Patent Literature 1: Japanese Patent No. 2870096

### SUMMARY OF THE INVENTION

Since the conventional device specifies the estimated trajectories of a host vehicle and a detected target vehicle, the intersection representing a collision can be immediately determined.

However, it is not always true that collisions occur only at the intersection of the trajectories because, in reality, the trajectories of the vehicle and the detected target vehicle cannot be uniquely determined, and the speeds of the vehicles are not constant. Therefore, warnings cannot be issued for collisions that might occur at sites other than an intersection.

If the movement of the host vehicle in all directions at all speeds is considered in order to detect collisions occurring at sites other than the above-described intersection, the computational cost becomes a problem. If the prediction range in which the host vehicle moves is improperly narrowed, a collision that requires a warning will not be predicted.

Accordingly, an object of at least one aspect of the present invention is to enable prediction of a collision that requires a warning to the driver while keeping a realistically low computational cost.

An information processing device according to an aspect of the invention, which is installed in a host vehicle, includes: a processor to execute a program; and a memory to store the program which, when executed by the processor, performs processes of, calculating braking time, the braking time being time required for the host vehicle to stop by braking; detecting reaction time, the reaction time being time required for a driver of the host vehicle to consider a countermeasure against a change in an environment of the host vehicle and execute the countermeasure; specifying longer prediction time as the sum of the braking time and the reaction time becomes longer, the prediction time being a range of a time at which a collision between the host vehicle and a surrounding vehicle is predicted in the future, the surrounding vehicle being a vehicle in the host vehicle's surroundings; making a prediction of a position and speed of the host vehicle and a position and speed of the surrounding vehicle at a time point included in the prediction time; and predicting, from a result of the prediction, whether or not the host vehicle and the surrounding vehicle will collide.

A non-transitory computer-readable storage medium according to an aspect of the invention, the non-transitory computer-readable storage medium storing a program that causes a computer installed in a host vehicle to execute processing comprising: calculating braking time, the braking time being time required for the host vehicle to stop by braking; detecting reaction time, the reaction time being time required for a driver of the host vehicle to consider a countermeasure against a change in an environment of the host vehicle and execute the countermeasure; specifying longer prediction time as the sum of the braking time and the reaction time becomes longer, the prediction time being a range of a time at which a collision between the host vehicle and a surrounding vehicle is predicted in the future, the surrounding vehicle being a vehicle in the host vehicle's surroundings; making a prediction of a position and speed of the host vehicle and a position and speed of the surrounding vehicle at a time point included in the prediction time; and predicting, from a result of the prediction, whether or not the host vehicle and the surrounding vehicle will collide.

An information processing method according to an aspect of the invention includes: calculating braking time, the braking time being time required for a host vehicle to stop by braking; detecting reaction time, the reaction time being time required for a driver of the host vehicle to consider a countermeasure against a change in an environment of the host vehicle and execute the countermeasure; specifying longer prediction time as the sum of the braking time and the reaction time becomes longer, the prediction time being a range of a time at which a collision between the host vehicle and a surrounding vehicle is predicted in the future, the surrounding vehicle being a vehicle in the host vehicle's surroundings; making a prediction of a position and speed of the host vehicle and a position and speed of the surrounding vehicle at a time point included in the prediction time; and predicting, from a result of the prediction, whether or not the host vehicle and the surrounding vehicle will collide.

According to at least one aspect of the present invention, a collision that requires a warning to the driver can be predicted while keeping a realistically low computational cost.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating the configuration of a collision prediction device according to an embodiment;

FIG. 2 is a schematic diagram for explaining a device installed in a vehicle;

FIG. 3 is a block diagram schematically illustrating the hardware configuration of the collision prediction device according to an embodiment; and

FIG. 4 is a flowchart illustrating the operation of the collision prediction device according to an embodiment.

### DETAILED DESCRIPTION OF THE INVENTION

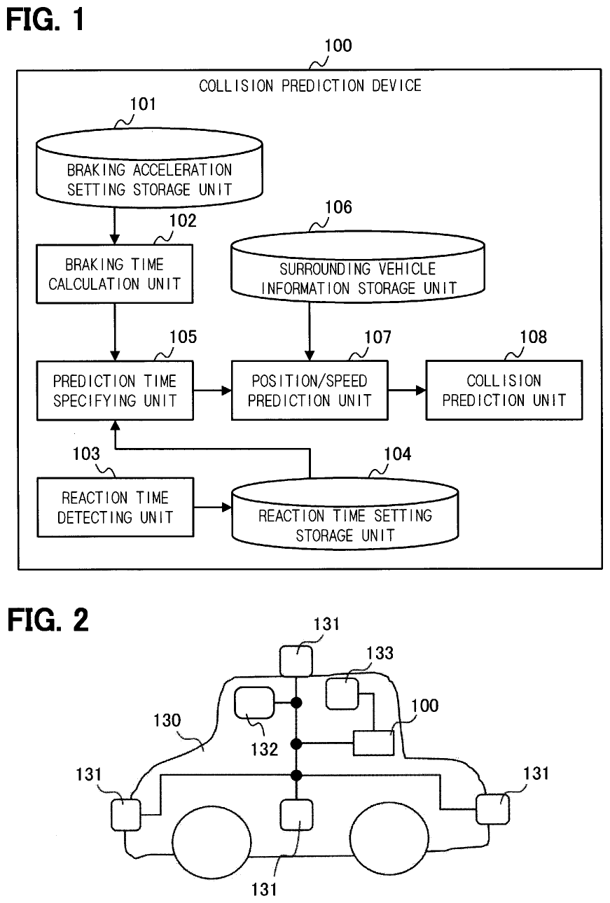

FIG. 1 is a block diagram schematically illustrating the configuration of a collision prediction device 100, which is an information processing device according to an embodiment.

The collision prediction device 100 includes a braking acceleration setting storage unit 101, a braking time calculation unit 102, a reaction time detecting unit 103, a reaction time setting storage unit 104, a prediction time specifying unit 105, a surrounding vehicle information storage unit 106, a position/speed prediction unit 107, and a collision prediction unit 108.

The collision prediction device 100 is installed in a host vehicle 130, for example, as illustrated in FIG. 2.

FIG. 2 is a schematic diagram for describing the device installed in the host vehicle 130.

In addition to the collision prediction device 100, the host vehicle 130 is provided with surrounding monitoring sensors 131, an image sensor 132 serving as an image capturing device, and a warning device 133.

The surrounding monitoring sensors 131 are installed on the front, rear, sides, and roof of the host vehicle 130. Note that the surrounding monitoring sensors 131 need not be installed at all of these positions, and may be installed at other positions.

The surrounding monitoring sensors 131 measure the relative positions and the relative speeds of the surrounding vehicles (not illustrated) and the host vehicle 130 to detect the surrounding vehicles, which are vehicles in the surroundings of the host vehicle 130. The surrounding monitoring sensors 131 then send the measured values to the collision prediction device 100.

The image sensor 132 acquires an image in the traveling direction of the host vehicle 130 and supplies image information indicating the acquired image to the collision prediction device 100.

The warning device 133 issues a warning to the driver of the host vehicle 130.

When the warning device 133 receives the probability of a collision as input, and when the probability exceeds a preset threshold value, the warning device 133 issues a warning to the driver by display on a display device (not illustrated) or sound reproduction through a speaker (not illustrated).

The collision prediction device 100 is connected to a controller area network (CAN) of the host vehicle 130 and can acquire information indicating operation of the accelerator pedal, a detection result of a raindrop sensor, and vehicle speed information, from an electronic control unit (ECU) connected to the CAN.

To return to FIG. 1, the braking acceleration setting storage unit 101 stores information necessary for calculating the braking time of the host vehicle 130. For example, the braking acceleration setting storage unit 101 stores the vehicle speed of the host vehicle 130, the detection result of the raindrop sensor, the friction coefficient of the road, and the gravitational acceleration.

In this example, the friction coefficient of wet asphalt and the friction coefficient of dry asphalt are stored as the friction coefficient of the road. The friction coefficient of wet asphalt is typically within the range of 0.4 to 0.6, and, in this example, the smallest value, 0.4, is stored. The friction coefficient of dry asphalt is typically within the range of 0.7 to 0.8, and, in this example, the smallest value, 0.7, is stored.

The gravitational acceleration is approximately 9.8 meters per second squared.

The braking time calculation unit 102 calculates the braking time, which is the time required for the host vehicle 130 to stop by braking. The braking time is calculated from the presumed friction coefficient of the road surface and the current vehicle speed. For example, the braking time s is determined by the following equation (1):

s=v/(μ·g) (1)

In this example, v is the vehicle speed of the host vehicle 130, μ is the friction coefficient, and g is the gravitational acceleration. These are stored in the braking acceleration setting storage unit 101.

The braking time calculation unit 102 determines the friction coefficient to be used on the basis of the detection result of the raindrop sensor. Specifically, when the detection result of the raindrop sensor indicates that raindrops are detected, i.e., rain is falling, the friction coefficient of wet asphalt is to be used, and when the detection result of the raindrop sensor indicates that no raindrops are detected, i.e., rain is not falling, the friction coefficient of dry asphalt is to be used.

The reaction time detecting unit 103 detects the reaction time that is the time required for the driver to consider a countermeasure against a change in the environment around the host vehicle 130 and execute the countermeasure, and stores the detected reaction time in the reaction time setting storage unit 104.

For example, the reaction time detecting unit 103 detects a traffic light from the image indicated by the image information from the image sensor 132, and specifies the time point at which the detected traffic light changes from a red light indicating “stop” to a green light indicating “go.” The reaction time detecting unit 103 then specifies the time point at which the driver operates the accelerator pedal after the light has changed to a green light, on the basis of the information indicating the operation of the accelerator pedal acquired from the ECU via the CAN. The reaction time detecting unit 103 sets the time difference between the time point at which the traffic light changed and the time point at which the accelerator pedal was operated as the reaction time.

The prediction time specifying unit 105 specifies the prediction time that is the range of the time point at which the position/speed prediction unit 107 and the collision prediction unit 108 in the subsequent stage perform prediction processing. For example, as the sum of the braking time and the reaction time becomes longer, the prediction time specifying unit 105 specifies longer prediction time that is a range of the time point at which a collision between the host vehicle 130 and a surrounding vehicle is predicted in the future. In this example, the prediction time is specified by adding the braking time, the reaction time, and preset time.

Specifically, the prediction time specifying unit 105 limits the range of the time point step k+n (where k and n are positive integers) to the range indicated by the following equations (2) and (3). The time point step k+n is the time point at which the prediction time specifying unit 105, the position/speed prediction unit 107, and the collision prediction unit 108 perform the prediction processing.

M={n:0<n≤m} (2)

m=<<(r+s+α)/Δt>> (3)

In this example, M is a set of prediction time point steps, whereby the time point at which the position/speed prediction unit 107 and the collision prediction unit 108 perform the prediction processing is determined to be within the range of time point step k to time point step k+m.

The cycle in which the position/speed prediction unit 107 and the collision prediction unit 108 operate is represented by Δt, the braking time is represented by s, and the reaction time is represented by r.

An integer obtained by rounding up the first decimal place of the real number a is represented by <<a>>. A set value of a delay time from the prediction of a collision until the time point at which braking must be started in order to stop the host vehicle 130 before it collides with a surrounding vehicle is represented by α.

The surrounding vehicle information storage unit 106 stores the position and speed of the surrounding vehicle. For example, the position/speed prediction unit 107 may calculate the absolute position and the absolute speed of the surrounding vehicle from the relative position and the relative speed of the surrounding vehicle detected by the surrounding monitoring sensors 131 and may store the calculated absolute position and the absolute speed as the position and the speed of the surrounding vehicle in the surrounding vehicle information storage unit 106.

The surrounding vehicle information storage unit 106 stores the estimated value of the state value predicted by the position/speed prediction unit 107 and the error covariance. The state value includes position and speed.

The position/speed prediction unit 107 executes prediction of the position and speed of the host vehicle 130 and the position and speed of the surrounding vehicle at a time point included in the prediction time. For example, the position/speed prediction unit 107 uses a Kalman filter to predict the position and speed of the surrounding vehicle in the future from the position and speed of the surrounding vehicle stored in the surrounding vehicle information storage unit 106, as follows.

<Estimation Processing of Position/Speed Prediction Unit 107>

In the following explanation, the surrounding vehicle is limited to one vehicle.

In this example, the front direction of the vehicle 130 illustrated in FIG. 1 is defined as the Y-axis direction, the right direction of the vehicle 130 is defined as the X-axis direction, and the X-axis and the Y-axis are orthogonal to each other.

When the state value of the surrounding vehicle is defined as xₖ=[pₓₖ p_{yk} vₓₖ v_{yk}]^{T} including the X-coordinate pₓₖ and the Y-coordinate p_{yk} of the position of the surrounding vehicle and the X-axis component vₓₖ and the Y-axis component v_{yk} of the speed of the surrounding vehicle at a time point step k, the state equation representing uniform motion is expressed by the following equation (4):

xₖ=F·xₖ₋₁ (4)

F is a linear model of time transition by uniform motion and is expressed by the following equation (5):

$$F = [ \begin{matrix}1 & 0 & Δ t & 0 \\ 0 & 1 & 0 & Δ T\end{matrix} ] \qquad ( 5 )$$

F is a linear model that gives the state value motion for time Δt. In a typical Kalman filter, a term of control input to the system to be estimated and a term of process noise generated during operation of the system are included in the state equation; however, since the control input and the process noise generated in the surrounding vehicle are unknown in this example, the control input and the process noise are ignored by using zero vectors for these terms.

Then, the relationship between the state value xₖ of the surrounding vehicle and the observed value zₖ obtained by observing the surrounding vehicle by the surrounding monitoring sensors 131 is presumed as follows.

Zₖ=H·xₖ+vₖ

H is a mapping from a state space to an observation space; and in this example, H is a unit matrix under the presumption that both the state space and the observation space are in the Euclidean space of position and speed.

It is presumed that vₖ is observation noise of the surrounding monitoring sensors 131 and follows a Gaussian distribution of N(0,R). The variance R is a 4 by 4 covariance matrix.

Next, if x\hat{ }ₖ is the estimated value of xₖ and Pₖ is the error covariance of x\hat{ }ₖ, then x\hat{ }ₖ and Pₖ are expressed by the following equations (6) to (10) using the estimated value x\hat{ }ₖ₋₁ of the previous time point step k−1, its error covariance Pₖ₋₁, and the observed value zₖ of the current time point step k.

x\hat{ }ₖ=x\hat{ }_{k|k-1}+Kₖ·(zₖ−H·x\hat{ }_{k|k-1}) (6)

Pₖ=(I−Kₖ·H)·P_{k|k-1} (7)

Kₖ=P_{k|k-1}·H^{T}(R+H·P_{k|k-1}·H^{T})⁻¹ (8)

x\hat{ }_{k|k-1}=F·x\hat{ }ₖ₋₁ (9)

P_{k|k-1}=F·Pₖ₋₁·F^{T} (10)

Here, x\hat{ }_{k|k-1} is the predicted value of the next time point step k predicted on the basis of the estimated value of the time point step k−1, and P_{k|k-1} is its error covariance. The symbol “\hat{ }” indicates an estimated value.

The position/speed prediction unit 107 reads the estimated value x\hat{ }ₖ₋₁ of the previous time point step k−1 and the error covariance Pₖ₋₁ from the surrounding vehicle information storage unit 106, and, on the basis of these values, records the estimated value x\hat{ }ₖ of the current time point step k estimated as described above and the error covariance Pₖ for the next time point step in the surrounding vehicle information storage unit 106.

Note that since there are usually multiple surrounding vehicles, the position/speed prediction unit 107 records, in the surrounding vehicle information storage unit 106, the state value including position and speed and the error covariance for each of the surrounding vehicles.

<Estimation Processing Method of Position/Speed Prediction Unit 107>

By using a state transition model F(t), such as this below, the estimated value of not only the next time point step k+1 but also any time point step k+n can be predicted as the following equations (11) to (13) on the basis of the estimated value x\hat{ }ₖ and the error covariance Pₖ at the current time point step k.

$$\begin{matrix}{x}^{{⋀}_{k + n \vert k}} = F ( n ) \cdot {x}^{{⋀}_{k}} & ( 11 ) \\ {P}_{k + n \vert k} = F ( n ) \cdot {P}_{k} \cdot {F ( n )}^{T} & ( 12 ) \\ {F}_{n} = [ \begin{matrix}1 & 0 & Δ t & 0 \\ 0 & 1 & 0 & Δ T\end{matrix} ] & ( 13 )\end{matrix}$$

Alternatively, the prediction may be performed by the following equations (14) to (16).

$$\begin{matrix}{x}^{{⋀}_{k + n \vert k}} = F \cdot {x}^{{⋀}_{k + n - 1 \vert k}} & ( 14 ) \\ {P}_{k + n \vert k} = F \cdot {P}_{k + n - 1 \vert k} {P}_{k + n - 1 \vert k} \cdot {F}^{T} & ( 15 ) \\ F = [ \begin{matrix}1 & 0 & Δ t & 0 \\ 0 & 1 & 0 & Δ T\end{matrix} ] & ( 16 )\end{matrix}$$

where, n is an integer of which the maximum value is the maximum predicted time point step k+m as described above.

<Linking Processing of Position/Speed Prediction Unit 107>

The linking between the estimated values stored in the surrounding vehicle information storage unit 106 and updated observed values will now be described for the case in which multiple surrounding vehicles are traveling.

At the time point step k, it is necessary to link the I observed values z_{i,k} (where i=1, 2 . . . , I, and I is a positive integer) observed when the I surrounding vehicles are traveling around the host vehicle 130 to one of the estimated values of the J surrounding vehicles (where J is a positive integer) of which the position and speed are already predicted by the Kalman filter.

As a general policy, the observed value whose distance is the closest to the predicted position of the surrounding vehicle at the current time point step that has already been predicted at the previous time point step is adopted as the observed value of the surrounding vehicle, and the observed value is linked to the estimated value. However, even if the observed value is the closest to the predicted position, the observed value is not adopted as the observed value of the surrounding vehicle and a link is not established if the distance exceeds a threshold value.

Out of the J surrounding vehicles, the surrounding vehicles not linked to any of the observed values are presumed to have moved out of sight, and their estimated values and error covariances are deleted from the surrounding vehicle information storage unit 106 and are not handled by the position/speed prediction unit 107 thereafter.

In contrast, an observed value that is not linked to any of the surrounding vehicles is regarded as to be belonging to a newly detected surrounding vehicle, and the observed value is regarded as the estimated value of the time point step and stored in the surrounding vehicle information storage unit 106. For the error covariance of the updated observed value, the variance R of the observation noise or a zero matrix is used.

The distance for linking is measured as follows.

First, if a multivariate Gaussian distribution g_{j,k}(X) is considered in which the position Y·x\hat{ }_{k|k-1} at the time point step k predicted at the time point step k−1 is defined as the mean value and the error covariance Y·P_{j,k|k-1}·Y^{T} is defined as the variance for each of the J surrounding vehicles o\hat{ }ⱼ, g_{j,k}(X) represents the probability of the surrounding vehicle o\hat{ }ⱼ being at the position X. In other words, g_{j,k}(Y·z_{i,k}) represents the probability of the surrounding vehicle o\hat{ }ⱼ being at the observed position Y·z_{i,k}.

To reduce the distance from a more plausible observed value, 1/g_{j,k}(Y·z_{i,k}) or 1−g_{j,k}(Y·z_{i,k}) shall be the distance to be measured for the linking. Here, Y is a matrix such as the following equation (17) for extracting only the position from the position speed x\hat{ }_{k|k-1}.

$$Y = [ \begin{matrix}1 & 0 & 0 & 0 \\ 0 & 1 & 0 & 0\end{matrix} ] \qquad ( 17 )$$

The collision prediction unit 108 predicts a collision between the host vehicle 130 and the surrounding vehicle from the result of the prediction by the position/speed prediction unit 107. For example, the collision prediction unit 108 predicts the occurrence of a collision on the basis of the probability of a collision occurring at any time point step and any position, as described below.

If a multivariate Gaussian distribution g_{j,k,n}(x) is considered in which the position Y·x\hat{ }_{k+n|k-1} at the time point step k+n is defined as the mean value and the error covariance Y·P_{j,k+n|k-1}·Y^{T} is defined as the variance at the time point step k+n on the basis of the prediction at the time point step k, this represents the surrounding vehicle position probability, which is the probability at which the surrounding vehicle o\hat{ }ⱼ is at the position x at the time point step k+n.

Similarly, if the target vehicle position probability, which is the probability of the host vehicle 130 being at the position x, is determined as f_{k,n}(x) at the time point step k+n on the basis of the prediction of the position and speed of the host vehicle 130, the collision probability h_{k,n}(x), which is the probability of the host vehicle 130 and one of the surrounding vehicles being at the same coordinate x, i.e., the probability of collision, is expressed by the following equation (18).

$$\begin{matrix}[ Expression 1 ] & \\ {h}_{k , n} ( x ) = {f}_{k , n} ( x ) \cdot \{ 1 - {\prod }_{j ∈ J} ( 1 - {g}_{j , k , n} ( x ) ) \} & ( 18 )\end{matrix}$$

Therefore, the occurrence of the predicted collision can be determined by the following equation (19) depending on whether or not the collision probability h_{k,n}(x) exceeds a threshold value λ.

$$\begin{matrix}[ Expression 2 ] & \\ {max}_{m ∈ M , x ∈ X} ( {h}_{k , n} ( x ) ) > λ & ( 19 )\end{matrix}$$

However, the position range X is a range in which the target vehicle position probability f_{k,n}(x) exceeds the threshold value λ, as expressed by the following equation (20).

X={x:f_{k,n}(x)>λ} (20)

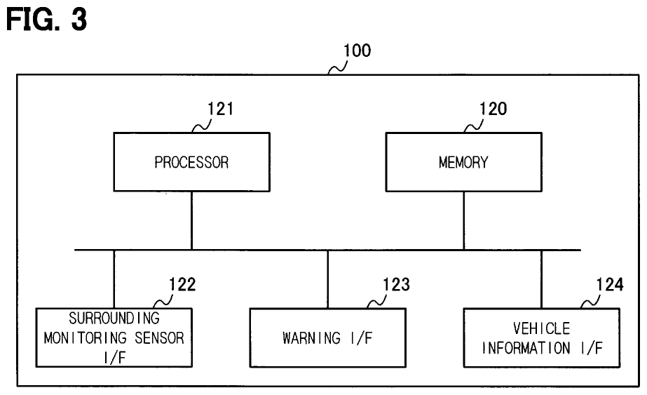

FIG. 3 is a block diagram schematically illustrating the hardware configuration of the collision prediction device 100 according to an embodiment.

The collision prediction device 100 includes a memory 120, a processor 121, a surrounding monitoring sensor interface (I/F) 122, a warning I/F 123, and a vehicle information I/F 124.

The function of the collision prediction device 100 is stored as a program in the memory 120, and the processor 121 reads and executes the program.

The collision prediction device 100 includes the environment monitoring sensor I/F 122, and an environment monitoring sensor 111 for measuring the environment of the host vehicle 130 is connected to the environment monitoring sensor I/F 122. The program to be executed by the processor 121 can access the relative positions and the relative speeds of other vehicles relative to the host vehicle, which are sensor data of the environment monitoring sensor 111. As described below, the absolute speeds of the surrounding vehicles can be obtained on the basis of the speed of the host vehicle 130 and the relative speeds of the surrounding vehicles.

The collision prediction device 100 includes the warning I/F 123, and the warning device 133 is connected to the warning I/F 123. The program to be executed by the processor 121 can present a warning to the driver of the host vehicle 130 through the warning device 133.

The collision prediction device 100 includes the vehicle information I/F 124, and the CAN of the host vehicle 130 is connected to the vehicle information I/F 124. The program to be executed by the processor 121 can access information of the accelerator pedal, the brake pedal, and the raindrop sensor, and vehicle speed information.

Such a program may be provided via a network or may be recorded and provided on a recording medium such as a non-transitory computer-readable storage medium. That is, such a program may be provided as, for example, a program product. Therefore, the collision prediction device 100 can be implemented by a computer executing such programs.

The operation will now be explained.

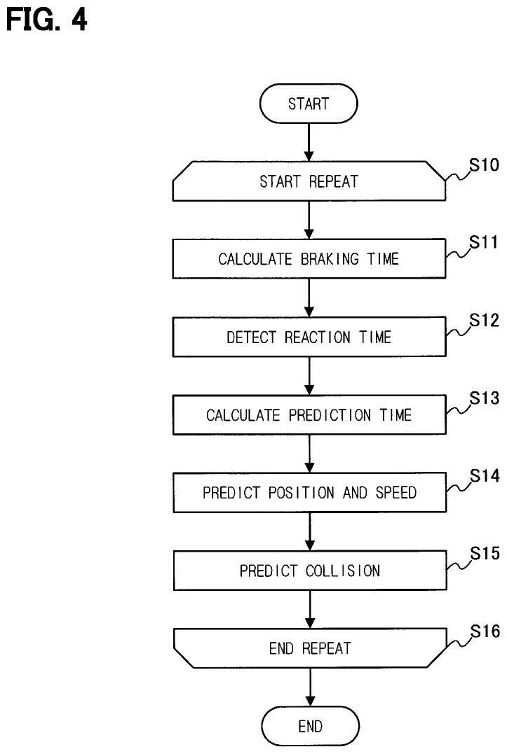

FIG. 4 is a flowchart illustrating the operation of the collision prediction device 100 according to an embodiment.

The collision prediction device 100, as indicated in steps S10 and S16 in FIG. 4, repeats the processing in steps S11 to S15 at a cycle Δt during the time from the start of the operation in response to the power being turned on to the end of the operation in response to the power being turned off or the like.

In step S11, the braking time calculation unit 102 calculates the braking time s on the basis of the vehicle speed v of the vehicle 130, the friction coefficient μ, and the gravitational acceleration g.

In step S12, the reaction time detecting unit 103 measures the reaction time of the driver of the host vehicle 130 and records the reaction time in the reaction time setting storage unit 104.

In step S13, the prediction time specifying unit 105 calculates a prediction time point step set M corresponding to the prediction time during which prediction of a collision is performed on the basis of the braking time s and the reaction time r.

In step S14, the position/speed prediction unit 107 determines estimated values of the state values at the current time point step using the positions and speeds of the surrounding vehicles detected by the surrounding monitoring sensors 131 as the observed values, and on the basis of the estimated values, predicts the positions and speeds of the surrounding vehicles at each time point step in the range of the prediction time point step set M.

In step S15, the collision prediction unit 108 calculates the probability of a collision between the vehicle 130 and one of the surrounding vehicles on the basis of the positions and speeds of the host vehicle 130 and the surrounding vehicles at each time point step in the range of the prediction time point step set M, and outputs the probability to the warning device 133.

As described above, according to the present embodiment, since the time range of the prediction processing is limited on the basis of the reaction time of the driver, collisions that require warnings to the driver are fully predicted, and the computational cost can be reduced.

### DESCRIPTION OF REFERENCE CHARACTERS

100 collision prediction device; 101 braking acceleration setting storage unit; 102 braking time calculation unit; 103 reaction time detecting unit; 104 reaction time setting storage unit; 105 prediction time specifying unit; 106 surrounding vehicle information storage unit; 107 position/speed prediction unit; 108 collision prediction unit; 130 host vehicle; 131 surrounding monitoring sensor; 132 image sensor; 133 warning device.

What is claimed is:

1. An information processing device installed in a host vehicle, the device comprising:
a processor to execute a program; and
a memory to store the program which, when executed by the processor, performs processes of,
calculating braking time, the braking time being time required for the host vehicle to stop by braking;
detecting reaction time, the reaction time being time required for a driver of the host vehicle to consider a countermeasure against a change in an environment of the host vehicle and execute the countermeasure;
specifying longer prediction time as the sum of the braking time and the reaction time becomes longer, the prediction time being a range of a time at which a collision between the host vehicle and a surrounding vehicle is predicted in the future, the surrounding vehicle being a vehicle in the host vehicle's surroundings;
making a prediction of a position and speed of the host vehicle and a position and speed of the surrounding vehicle at a time point included in the prediction time; and
predicting, from a result of the prediction, whether or not the host vehicle and the surrounding vehicle will collide.

2. The information processing device according to claim 1, wherein the processor is configured to specify the prediction time by adding the braking time, the reaction time, and predetermined time.

3. The information processing device according to claim 1, wherein the processor is configured to detect the reaction time based on a time point from a traffic light changing from stop to go until the driver operating an accelerator pedal of the host vehicle.

4. The information processing device according to claim 3, wherein the processor is configured to specify the time point at which the signal changes from stop to go based on an image acquired from an image capturing device attached to the host vehicle.

5. The information processing device according to claim 3, wherein the processor is configured to obtain information indicating operation of the accelerator pedal from an electronic control unit of the host vehicle to specify a time point at which the accelerator pedal was operated.

6. The information processing device according to claim 1, wherein the processor is configured to calculate the braking time by dividing the speed of the host vehicle by the product of a friction coefficient of the road and the gravitational acceleration.

7. The information processing device according to claim 6, wherein the processor is configured to obtain information indicating whether or not a raindrop sensor attached to the host vehicle has detected raindrops from the electronic control unit of the host vehicle, and is configured, when raindrops have been detected, to set the friction coefficient to a value smaller than when raindrops have not been detected.

8. A non-transitory computer-readable storage medium storing a program that causes a computer installed in a host vehicle to execute processing comprising:
calculating braking time, the braking time being time required for the host vehicle to stop by braking;
detecting reaction time, the reaction time being time required for a driver of the host vehicle to consider a countermeasure against a change in an environment of the host vehicle and execute the countermeasure;
specifying longer prediction time as the sum of the braking time and the reaction time becomes longer, the prediction time being a range of a time at which a collision between the host vehicle and a surrounding vehicle is predicted in the future, the surrounding vehicle being a vehicle in the host vehicle's surroundings;
making a prediction of a position and speed of the host vehicle and a position and speed of the surrounding vehicle at a time point included in the prediction time; and
predicting, from a result of the prediction, whether or not the host vehicle and the surrounding vehicle will collide.

9. An information processing method comprising:
calculating braking time, the braking time being time required for a host vehicle to stop by braking;
detecting reaction time, the reaction time being time required for a driver of the host vehicle to consider a countermeasure against a change in an environment of the host vehicle and execute the countermeasure;
specifying longer prediction time as the sum of the braking time and the reaction time becomes longer, the prediction time being a range of a time at which a collision between the host vehicle and a surrounding vehicle is predicted in the future, the surrounding vehicle being a vehicle in the host vehicle's surroundings;
making a prediction of a position and speed of the host vehicle and a position and speed of the surrounding vehicle at a time point included in the prediction time; and
predicting, from a result of the prediction, whether or not the host vehicle and the surrounding vehicle will collide.
